(19) United States
(12) Patent Application Publication
(10) Pub. No.: US 2014/0263021 A1
(43) Pub. Date: Sep. 18, 2014

(54) Plate Filtering Device for Plastic Melts

(71) Applicant: KREYENBORG GMBH, Muenster (DE)

(72) Inventors: Stefan Woestmann, Fuechtorf (DE); Jan-Udo Kreyenborg, Muenster (DE)

(73) Assignee: KREYENBORG GMBH, Muenster (DE)

(21) Appl. No.: 14/290,675

(22) Filed: May 29, 2014

Related U.S. Application Data
(63) Continuation of application No. 12/845,031, filed on Jul. 28, 2010, now abandoned.

(30) Foreign Application Priority Data
Jul. 31, 2009 (DE) 10 2009 035 790.4

(51) Int. Cl. B01D 35/30

(52) U.S. Cl. CPC B01D 35/306
USPC 210/236

(57) ABSTRACT

A plate filtering device (10) for plastic melts has at least two stationary housing components (7, 9) with a movable plate (4) with a filter insert (5) disposed between them. A locking bushing (6) that extends up to the movable plate is placed at the downstream housing component (9), and its inner recess forms a part of the flow channel. A seal bushing (3) that can be pressed against the movable plate (4) and/or the filter insert (5) is located in movable fashion in the front housing component (7). A funnel area (3.2) is formed on the side facing away from the filter insert (5). A sealing ring (2) is located between the sealing bushing (3) and a retaining ring (1). The sealing ring exhibits at least one angled conical surface (2.1) and one face area (2.2) that is oriented at a right angle to the direction of fluid flow. At the seal bushing (3), an effective pressure area (3.1, 3.1′, 3.1″) that extends into the flow channel (8) is formed within the inner width of the sealing ring (2).

### RELATED APPLICATIONS

This patent application is a continuation of U.S. patent application Ser. No. 12/845,031 filed on Jul. 28, 2010, which claims priority to German Patent Application No. DE 10 2009 035 790.4 filed on Jul. 31, 2009, the entire contents of both of which are hereby incorporated by reference herein.

### BACKGROUND OF THE INVENTION

The present invention relates to a plate filtering device for plastic melts (melted liquified plastic) having at least two stationary housing components, between which can be inserted a movable plate with one filter insert therein, and wherein:
a locking bushing that extends up to the movable plate is placed at the downstream housing component, with its inner recess forming a part of a flow channel for the melts;
a seal bushing that can be pressed against at least one of the movable plate and the filter insert is located in a movable manner in the front housing component, and a funnel area is formed at the side facing away from the filter insert, and
a sealing ring is located between the seal bushing and a retaining ring, which sealing ring exhibits at least one angled conical surface and one face area that is oriented at a right angle to the direction of fluid flow.

Plate filtering devices constitute cost-effective options for filtering plastic melts. A plate that includes the filtering element is arranged between two stationary housing components. The movable plate can be pivoted or pushed out of the gap between the fixed housing components such that the filter insert is accessible for cleaning For this device—in its basic design a very simple and robust device—it is particularly important to seal the respective gap between a stationary housing component and a movable plate, when the movable plate is in its operating position. A certain gap dimension must be ensured to enable the movement of the plate. On the other hand, there should be no gap during operation through which the plastic melt can escape.

Known from U.S. Pat. No. 7,147,774 is a plate filtering device of this type with a seal comprised of a seal bushing and a sealing ring. The seal bushing exhibits a funnel-shaped inlet opening when viewed in the direction of the plastic flow. The sealing ring features a cone-shaped section compatible with the inlet opening. The cone angle of the funnel-shaped opening matches the cone-shaped section. The sealing ring is designed such that it can expand due to the stagnation pressure of the plastic melt that is present in the flow channel. Via the coupling of the cone surfaces, the radially outward acting force then affects an axial advance motion of the seal bushing up to the movable plate. At the same time, the plate is pressed onto a rear locking bushing, such that the two gaps—in the direction of flow before and after the filter—are bridged between the stationary housing components and the movable plates. This creates a reliable sealing system. However, its manufacture is complex and thus cost-intensive because it comprises several arc-shaped segments that are cut out of a turning workpiece using wire eroding. Because of the width of the cuts, the segments placed together after separation will no longer form a closed circle. For this reason, at least one of the segments must be cut out of a second turning workpiece. A reliable sealing system is achieved only with excellent manufacturing precision. Because plate filtering devices are intended for simple applications and can thus achieve only small yields, a complex design of the described seal is economically not justifiable.

One-piece sealing rings made of high-temperature resistant synthetics such as PTFE and utilizing thermal expansion are known as well. However, all plate filtering devices of the type mentioned above have in common that they use an indirect active principle: The radial movement of the segments or the radial lengthening of the one-piece ring leads to a transfer of force to the angular surface. An advance of the seal bushing onto the filter insert is achieved only through partial sliding of the angular surface of the sealing ring on the funnel surface of the seal bushing. The sliding movement requires precise surface-finishing, which in turn increases the manufacturing costs. Furthermore, the seal will fail if the sliding motion is blocked by dirt.

### SUMMARY OF THE INVENTION

A principal objective of the present invention is to achieve a reliable seal for the movable plate in a plate filtering device.

This objective, as well as other objectives which will become apparent from the discussion that follows, are achieved, according to a first embodiment of the present invention, by a plate filtering device in which the advance movement of the seal bushing is achieved through the effective pressure area that protrudes into the flow opening cross-section of the flow channel. In this manner, the invention utilizes the pressure effect of the melt directly and utilizes the radial expansion of the sealing ring on the angular and funnel surfaces only for a tight contact; i.e., for sealing purposes.

Physically effective is the imaginary sealing ring area of a projection of the actually formed effective pressure area in a plane that extends perpendicular to the direction of flow. Because the effective pressure area protrudes radially only a few millimeters into the flow channel and in addition is positioned at an angle or is rounded, the flow resistance is negligible.

In this way, a multi-part sealing element becomes optional. Retaining the conical surface at the inlet of the seal bushing and retaining a sealing ring with matching conical angle serves the purpose of achieving a seal radially outside of the effective pressure area.

Thus, a flexible sealing ring may be used—for example, one made of PTFE—which can be stretched radially to the extent that it rests with its own conical surface tightly against the conical funnel inlet of the seal bushing.

The other outer surface points toward the rear and rests against the face of a retaining ring. Thus, as soon as stagnation pressure is present in the flow channel, the sealing ring with its conical cross-section is pressed between the seal bushing and the retaining ring, such that the flow channel is sealed entirely on the flow inlet side of the filter element.

According to a first variation, the effective pressure area is formed by an incline that follows the inner diameter of the sealing ring and, in particular, is designed as a projection of the cone-shaped funnel opening of the seal bushing. In this case, the angle of the effective pressure area in relation to the center axis of the flow channel is equal to the cone angle for the contact area of the sealing ring and is preferably 45°.

A different cone angle can be used as well, for example 30°-40°. This reduces the redirection of the melt at the border edges of the effective pressure area that reach into the flow channel.

In another variation, the profile of the seal bushing is flow-optimized in the effective pressure area in that the transition between the cone surface that forms the seal seat for the sealing ring and the walls of the flow channel are designed in a rounded manner.

In a second preferred embodiment of the present invention, the effective pressure area does not protrude into the flow channel originating from the inner diameter of the sealing ring. Instead, it is formed in such a way that the melt is allowed to enter between the retaining ring and the sealing ring so that the pressure of the melt can take effect at this location.

To this end, the sealing ring exhibits a recess at its front surface, viewed in the direction of flow, with this recess reaching across a portion of the radial extension of the sealing ring body. From the recess in the first face area, one or more bore holes then lead to the inner circumference such that the backed up melt can flow out through them.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a cross-sectional view showing a first embodiment of a plate filtering device according to the present invention.

FIGS. 2 and 3 are cross-sectional views showing variations of the embodiment of FIG. 1.

FIG. 4 is a cross-sectional view showing a second embodiment of a plate filtering device according to the present invention.

### DESCRIPTION OF THE PREFERRED EMBODIMENTS

The preferred embodiments of the present invention will now be described with reference to FIGS. 1-4 of the drawings. Identical elements in the various figures are designated with the same reference numerals.

FIG. 1 shows a plate filtering device 10 in which a movable plate 4 with a filter insert 5 on the inside is inserted between two plates 7, 9 acting as stationary housing components.

A locking bushing 6 is positioned in the downstream housing plate 9 when viewed in the direction of the flow. The inner recess of said locking bushing forms a flow channel downstream of the filter insert 5 and is changeable in its axial position in relation the plate 9, for example, by means of a thread.

A seal bushing 3 is inserted in the front housing plate 7. There is sufficient play between the housing plate 7 and the seal bushing 3 as to permit axial movement with respect to the movable plate 4 and the filter insert 5 is possible.

A sealing ring 2 is located upstream of the seal bushing 3 and a retaining ring 1, in turn, is located in front of the sealing ring. The sealing ring 2 has an angled surface 2.1 as well as a face area 2.2 arranged perpendicular to the direction of flow. The sealing ring 2 rests with its face area 2.2 against a rear face area 1.1 of the retaining ring 1. With its other angular area, it rests on a funnel area 3.2 of the seal bushing 3.

As a continuation of the funnel area 3.2, an effective pressure area 3.1 extends into the inside of the flow channel 8, which in the area upstream of the filter insert 5 is formed by the cylindrical wall 3.3 of the seal bushing 3.

If one projects the effective pressure area 3.1 that is formed on the three-dimensional sealing ring into a plane that is normal (i.e., vertical in all dimensions) to the direction of flow, then one obtains the actually effective area for calculating the forces that result from the stagnation pressure of the melt, with such forces acting upon the seal bushing 3 and pressing the same against the movable plate 4 or the filter insert 5, respectively.

The embodiment of a plate filtering device 10′ as shown in FIG. 2 differs from the one according to FIG. 1 only in that an effective pressure area 3.1′, positioned at an angle when viewed in its cross-section, is not formed as a direct extension from the funnel area 3.2′ for contact with a sealing ring 2 but rather is designed with a different cone angle α=30°-40°.

In the embodiment of a plate filtering device 10″ shown in FIG. 3, an effective pressure area 3.1″ is rounded in its cross-section and forms a flowing transition between a funnel area 3.2″ and the cylindrical wall 3.3″.

FIG. 4 shows a plate filtering device 20 that is essentially designed similar to the embodiments described previously.

The difference is that the effective pressure area does not extend into the inner width of the flow channel 8 but rather it extends radially outwards. Through a recess 22.5 that extends from the inner edge of the sealing ring 22 outward but, as mentioned, not across the entire width of the sealing ring 22, the melt can enter into the gap that is formed artificially between the retaining ring 21 and the sealing ring 22. In this manner, the pressure that is present in the melt acts upon this effective pressure area that is directed radially outwards and generates a force that acts upon the seal bushing 23 via the sealing ring 22 and presses this seal bushing onto the movable plate 4 or the filter insert 5, respectively.

Radially further outward, the recess 22.5 is limited in its position. There, the sealing ring 22 rests with its face area 22.2 tightly against the retaining ring 21.

There has thus been shown and described a novel plate filtering device for plastic melts which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A plate filtering device having a flow channel for plastic melt, said plate filtering device having at least two stationary housing components and a movable plate, said two stationary housing components comprising an upstream housing component and a downstream housing component, said movable plate having a filter insert and being positioned between said upstream housing component and said downstream housing component, said plate filtering device comprising:
a locking bushing positioned in said downstream housing component and extending up to said movable plate, said locking bushing having an inner recess that forms a part of said flow channel;
a seal bushing having opposed first and second sides, said first side facing away from said filter insert and having a funnel area, said second side configured to press against at least one of said movable plate and said filter insert, said seal bushing mounted to move axially in said upstream housing component; and
a sealing ring and a retaining ring, said sealing ring located between said seal bushing and said retaining ring, said sealing ring having an angled conical surface and a face area, said face area oriented at a right angle with respect to a direction of flow in said flow channel;
said seal bushing having an effective pressure area extending into said flow channel, said effective pressure area of said seal bushing located radially inwardly of said sealing ring.

2. A plate filtering device as set forth in claim 1, wherein said effective pressure area is formed by a radially inwardly projecting extension of said funnel area.

3. A plate filtering device as set forth in claim 2, wherein said effective pressure area has a cone angle different from that of the rest of said funnel area.

4. A plate filtering device as set forth in claim 1, wherein said effective pressure area is a continuation of said funnel area, is shaped as a curve in cross-section, and protrudes into said flow channel.

5. A plate filtering device as set forth in claim 1, wherein said locking bushing is movable axially relative to said downstream housing component.

6. A plate filtering device as set forth in claim 1, wherein said locking bushing is movable axially relative to said downstream housing component by means of threading.

7. A plate filtering device as set forth in claim 1, wherein said sealing ring is a single piece.

8. A plate filtering device as set forth in claim 1, wherein said effective pressure area extends radially into said flow channel such that pressure from melt moving through said flow channel bears directly against said effective pressure area of said seal bushing to press said seal bushing against said movable plate or said filter insert.

9. A plate filtering device as set forth in claim 1, wherein said sealing ring is flexible and has a conical cross-section.

10. A plate filtering device as set forth in claim 1, wherein said movable plate can be pivoted or pushed out from between said upstream and downstream housing components such that said filter insert is accessible for cleaning.

11. A plate filtering device as set forth in claim 1, wherein said effective pressure area is inclined, relative to a center axis of said flow channel, at an angle of 30-40 degrees.

12. A plate filtering device as set forth in claim 1, wherein said flow channel includes an area upstream of said filter insert, said seal bushing having a cylindrical wall surrounding said area upstream of said filter insert.

13. A plate filtering device having a flow channel for plastic melt, said plate-filtering device having at least two stationary housing components and a movable plate, said two stationary housing components comprising an upstream housing component and a downstream housing component, said movable plate having a filter insert and being positioned between said upstream housing component and said downstream housing component, said plate filtering device comprising:
a locking bushing positioned in said downstream housing component and extending up to said movable plate, said locking bushing having an inner recess that forms a part of said flow channel;
a seal bushing having opposed first and second sides, said first side facing away from said filter insert and having a funnel area, said second side configured to press against at least one of said movable plate and said filter insert, said seal bushing positioned movably in said upstream housing component; and
a sealing ring and a retaining ring, said sealing ring located between said seal bushing and said retaining ring, said sealing ring having an angled surface and a face area, said face area oriented at a right angle with respect to a direction of flow in said flow channel;
said sealing ring having an effective pressure area located radially outwardly of said flow channel.

14. A plate filtering device as set forth in claim 13, wherein said sealing ring has an inner edge, a recess, and one or more bore holes, said one or more bore holes extending radially outwardly from said inner edge to said recess, said recess being located at said face area to provide a gap between said retaining ring and said sealing ring, such that said effective pressure area is formed at said face area of said sealing ring.

15. A plate filtering device as set forth in claim 13, wherein said locking bushing is movable axially relative to said downstream housing component.

16. A plate filtering device as set forth in claim 13, wherein said locking bushing is movable axially relative to said downstream housing component by means of threading.

17. A plate filtering device as set forth in claim 13, wherein said sealing ring is a single piece.

18. A plate filtering device as set forth in claim 13, wherein said sealing ring is flexible and has a conical cross-section.

19. A plate filtering device as set forth in claim 13, wherein said flow channel includes an area upstream of said filter insert, said seal bushing having a cylindrical wall surrounding said area upstream of said filter insert.

20. A plate filtering device as set forth in claim 13, wherein said movable plate can be pivoted or pushed out from between said upstream and downstream housing components such that said filter insert is accessible for cleaning.
